(19) United States
(12) Patent Application Publication
(10) Pub. No.: US 2022/0248758 A1
(43) Pub. Date: Aug. 11, 2022

(54) CIGARETTE HEATING ASSEMBLY AND ELECTRIC HEATING SMOKING DEVICE

(71) Applicant: SHENZHEN FIRST UNION TECHNOLOGY CO., LTD., Shenzhen City, Guandong Province (CN)

(72) Inventors: BAOLING LEI, Shenzhen City, Guangdong Province (CN); JUN YUAN, Shenzhen City, Guangdong Province (CN); ZHENGFA LI, Shenzhen City, Guangdong Province (CN); ZHONGLI XU, Shenzhen City, Guangdong Province (CN); YONGHAI LI, Shenzhen City, Guangdong Province (CN)

(21) Appl. No.: 17/425,946

(22) PCT Filed: Jan. 17, 2020
(86) PCT No.: PCT/CN2020/072817

§ 371 Date: Jul. 26, 2021

(30) Foreign Application Priority Data
Jan. 26, 2019 (CN) 201920135544.7

(51) Int. Cl. A24F 40/46; A24F 40/20; A24F 40/51; A24F 40/57

(52) U.S. Cl. CPC A24F 40/46; A24F 40/57; A24F 40/51; A24F 40/20

(57) ABSTRACT

A cigarette heating assembly, includes a longitudinal heat conductive tube, a substrate layer and a resistance heating trace formed on the substrate layer. The resistance heating trace is located between the substrate layer and the heat conductive tube, and extends along a longitudinal direction of the heat conductive tube. A thermal conductivity of material of the heat conductive tube is larger than a thermal conductivity of material of the substrate layer. On the one hand, properties including electric resistance stability of the resistance heating trace and excellent heat conductivity of the cigarette heating assembly can be maintained. On the other hand, protection on two surfaces of the resistance heating trace is formed so that abrasion of the resistance heating trace caused by physical friction due to use in high temperatures can be avoided.

### BACKGROUND OF THE INVENTION

### 1. Field of the Invention

The present invention relates to a technical field of electronic cigarettes, particularly relates to a cigarette heating assembly and an electric heating smoking device.

### 2. The Related Arts

At present, the heating non-combustion cigarette electronic cigarette, one is to use a tubular heating element heated around to heat the cigarette; this type of tubular heating element is usually prepared by printing heating circuits on two substrates, ceramic or stainless steel.

The heating component of the ceramic substrate adopts a heating circuit printed on a flat ceramic green body, and then is wound into a circular tubular shape and sintered to obtain a ceramic heating tube that can contain and heat cigarettes. The heating element of the stainless steel substrate is obtained by sintering after printing a heating circuit on a stainless steel tube after surface insulation treatment.

The circuit printing of the ceramic substrate heating component is carried out on the flat ceramic green embryo, and the thickness consistency and resistance stability of the printed circuit obtained are better; but the thermal conductivity of the ceramic is relatively lacking, which can affect the temperature rise during the heating process of the cigarette. The speed is slow, and because of the slow heat conduction, the heat is mainly concentrated near the track of the printed circuit, and the cigarettes contained in the ceramic tube cannot be uniformly heated. The stainless steel substrate heating element has high thermal conductivity and thinner wall thickness, so its heating speed is fast, and the overall heating of the cigarette contained in the tube is more uniform; but because the heating circuit is printed on the tube during preparation, the printing. The lack of uniformity and consistency of the circuit thickness makes the resistance stability poor, which is not conducive to the heating temperature control of the product.

### SUMMARY OF THE INVENTION

In order to solve the problems of resistance stability and thermal conductivity of different preparation types of cigarette heating assemblies in the prior art, the embodiments of the present application provide a cigarette heating assembly with both resistance stability and thermal conductivity.

A cigarette heating assembly in accordance with the present invention includes a longitudinal heat conductive tube, a substrate layer and a resistance heating trace formed on the substrate layer. The heat conductive tube includes an inner surface and an outer surface oppositely facing each other along a radial direction of the heat conductive tube. The substrate layer is solidified on the outer surface of the heat conductive tube. The resistance heating trace is located between the substrate layer and the heat conductive tube, and extends along a longitudinal direction of the heat conductive tube. A thermal conductivity of material of the heat conductive tube is larger than a thermal conductivity of material of the substrate layer.

A heating cavity for accommodating cigarettes is formed on the inner surface.

Alternatively, the substrate layer includes a ceramic substrate layer, a thickness of the ceramic substrate layer is 0.05˜0.2 mm.

Alternatively, the ceramic substrate layer is made from a flexible flat plate-like ceramic wafer being wound and convoluted, and then sintered and solidified on the outer surface of the heat conductive tube. The resistance heating trace is a metal heating circuit printed on at least one flat surface of the flat plate-like ceramic wafer.

Alternatively, the heat conductive tube includes a metal tube having a thickness of 0.1˜0.2 mm.

Alternatively, an insulative layer is formed on an outer surface of the metal tube to electrically insulate the metal tube from the resistance heating trace.

Alternatively, the resistance heating trace includes one or a plurality of heating circuits in a spacing distribution, the plurality of heating circuits have specified temperature coefficients of resistance so that the plurality of heating circuits are not only used as an electric resistance heater, but also are used as a temperature sensor for sensing temperatures of the cigarette heating assembly.

Alternatively, the resistance heating trace includes at least a heating circuit and a temperature sensing circuit having different temperature coefficients of resistance.

A temperature coefficient of resistance of the heating circuit is set to satisfy use of an electric resistance heater, and a temperature coefficient of resistance of the temperature sensing circuit is set to satisfy use of a temperature sensor for sensing temperatures of the cigarette heating assembly.

Alternatively, the resistance heating trace includes at least a first heating trace and a second heating trace both of which are in a spacing distribution along the longitudinal direction of the heat conductive tube. The first heating trace and the second heating trace are used to heat different areas of the heating cavity distributed along the longitudinal direction of the heat conductive tube via heat conduction of the heat conductive tube along the radial direction of the heat conductive tube.

Alternatively, the first heating trace and the second heating trace are differentially respectively electrically connected with electrode pins for circuit input so that both of the first heating trace and the second heating trace are independently controlled for heating.

Alternatively, an electric heating smoking device in accordance with the present invention is further provided to include a cigarette heating device and a power source used for powering the cigarette heating device. The cigarette heating device adopts the above cigarette heating assembly.

A manufacturing method the above cigarette heating assembly in accordance with the present invention is proceeded by including the following steps.

A ceramic rough blank layer is acquired, and a heating precursor layer is formed on a surface of the ceramic rough blank layer to acquire a ceramic heating precursor.

The ceramic heating precursor is wound and convoluted on an outer surface of a heat conductive tube to form a heating assembly precursor.

The heating assembly precursor is baked and solidified under a temperature between 70˜100° C., and then the baked heating assembly precursor is sintered under a temperature between 800˜1,200° C. to acquire the cigarette heating assembly.

Alternatively, steps for acquiring the ceramic rough blank layer are as follows.

The ceramic powders are formulated based on a mass ratio of 45%˜50% of alumina, 35%˜40% of silicon dioxide, 5%˜10% of calcium oxide and 7%˜9% of magnesium oxide.

The ceramic rough blank layer is acquired by uniformly blending the ceramic powders with a sintering promoter and then being pressed together and shaped. The sintering promoter includes 75% to 80% of solvents, 10% to 15% of binders, 2.5% to 3.5% of dispersants and 5 to 10% of plasticizers.

Alternatively, the binders are at least one of polyvinyl alcohol, methyl cellulose or polyacrylic acid. The dispersants are at least one of sodium polyacrylate, sodium polyphosphate or sodium citrate. The plasticizers are at least one of dibutyl phthalate, glycerol, or polyethylene glycol.

In the above cigarette heating assembly of the present application, the resistance heating track has a dual substrate, wherein the substrate layer is used as the printing substrate in the preparation process, and the heat pipe is used as the sintering and bonding substrate after printing, and the heat conduction and heating process are combined. Disperse the base material; on the one hand, it can maintain stable resistance value of the resistance heating track and excellent heat conduction properties of the heating component during the preparation and use, and on the other hand, the heat pipe and the substrate layer can respectively form the two surfaces of the resistance heating track during use Protection to avoid the resistance change caused by the deformation of the resistance heating track caused by high temperature use, and the physical friction of the cigarette plugging and so on.

### BRIEF DESCRIPTION OF THE DRAWINGS

One or more embodiments in accordance with the present invention are illustratively exemplified for explanation through figures shown in the corresponding attached drawings. These exemplified descriptions do not constitute any limitation on the embodiments. The elements with the same reference numerals in the attached drawings are denoted as similar elements. Unless otherwise stated, the figures in the attached drawings do not constitute any scale limitation.

FIG. 1 shows a schematic perspective view of a cigarette heating assembly in accordance with a preferred embodiment of the present invention.

FIG. 2 shows a schematic cross-sectional view of the cigarette heating assembly of FIG. 1 along a radial direction of the cigarette heating assembly in accordance with a preferred embodiment of the present invention.

FIG. 3 shows a schematic side view of the cigarette heating assembly of FIG. 1 showing a ceramic substrate layer thereof and a resistance heating trace thereof extending along a circumferential direction of a heat conductive tube thereof in accordance with a preferred embodiment of the present invention.

FIG. 4 shows a schematic diagram showing a temperature raising test result of the cigarette heating assembly of FIG. 1 in accordance with a preferred embodiment of the present invention and a conventional ordinary ceramic heating tube.

### DETAILED DESCRIPTION OF PREFERRED EMBODIMENT

In order to facilitate best understanding of the present invention, the present invention will be illustrated in more detail below in conjunction with the attached drawings and preferred embodiments.

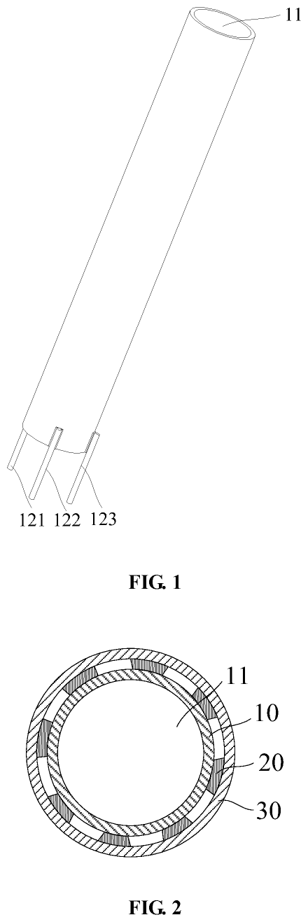

A manufacturing method of a cigarette heating assembly with electric resistance stability and heat conductivity in accordance with a preferred embodiment of the present invention is provided as follows. The cigarette heating assembly, manufactured based on a structure shown in FIGS. 1-3, includes a heat conductive tube 10, and a resistance heating trace 20 and a ceramic substrate layer 30 stacked and disposed in sequence outwards along a radial direction of the heat conductive tube 10. In addition, the ceramic substrate layer 30 is solidified on an outer surface of the heat conductive tube 10. The resistance heating trace 20 is located between the heat conductive tube 10 and the ceramic substrate layer 30, and extends along a longitudinal direction of the heat conductive tube 10.

Meanwhile, the ceramic substrate layer 30 is made of alumina ceramic, zirconia ceramic, or diatomaceous earth ceramic, etc. The heat conductive tube 10 is made of material with a good heat conductivity, including metal, alloy or non-metal material, such as stainless steel, aluminum alloy, zinc alloy, copper alloy, etc., or material with high heat conductivity of metal oxide, nitride and carbide, such as alumina, magnesium oxide, nickel oxide, aluminum nitride, silicon nitride, boron nitride, or silicon carbide, etc. The heat conductive tube 10 functions as heat conduction. In order to prevent heat from being conducted outwards by the ceramic substrate layer 30, a thermal conductivity of the heat conductive tube 10 is larger than a thermal conductivity of the ceramic substrate layer 30 so that heat in the cigarette heating assembly is used for heating.

Referring to the above structure of the cigarette heating assembly, the resistance heating trace 20 has double substrate materials. The ceramic substrate layer 30 is used as a printed substrate during manufacturing processes, and the heat conductive tube 10 is used as an assembled heat conductive substrate material after printed. On the one hand, properties including electric resistance stability and excellent heat conductivity of the cigarette heating assembly can be maintained during manufacture and in use. On the other hand, the heat conductive tube 10 and the ceramic substrate layer 30 can be used to respectively form protection on two lateral sides of the resistance heating trace 20 so that deformation of the resistance heating trace 20 causing change of an electric resistance value of the resistance heating trace 20 due to use of the resistance heating trace 20 in high temperatures can be avoided, and that abrasion of the resistance heating trace 20 caused by physical friction such as insertion of cigarettes, etc., can also be avoided.

Accordingly, based on the above, the ceramic substrate layer 30 is made from being sintered and solidified after the resistance heating trace 20 is printed on a non-sintered flat plate-like ceramic wafer, and then the printed ceramic wafer with the resistance heating trace 20 is wound and convoluted on the outer surface of the heat conductive tube 10. The ceramic wafer has a flexible property before the ceramic wafer is wound and convoluted on the outer surface of the heat conductive tube 10. The ceramic wafer can also be formed after coating a slurry blended from ceramic powders and a sintering promoter. Alternatively, an existing flexible ceramic paper available in the market can be adopted to form the ceramic wafer.

Since the heat conductive tube 10 is used to have functional settings for accommodating and heating cigarettes, an inner diameter of the heat conductive tube 10 is set to be adapted to a diameter of an ordinary cigarette, preferably to be 5˜6 mm.

Accordingly, smooth insertion of cigarettes into the heat conductive tube 10 can be guaranteed, and tight contact of the cigarettes with the heat conductive tube 10 is also ensured to enhance heating efficiency when the cigarettes are heated.

In the above structure of the cigarette heating assembly, the resistance heating trace 20 is preferably made by silk screen printing and sintering. Material of the resistance heating trace 20 is powders selected from ordinary pure nickel, nickel chromium alloy, ferro nickel alloy, ferro chromium alloy, ferro chromium aluminum alloy, tungsten, platinum, titanium alloy or stainless steel, etc. The selected powders are blended with a slurry and then are printed based on a designed pattern to acquire the resistance heating trace 20. The ceramic substrate layer 30 used as a printed substrate and a protective layer preferably has a thickness of 0.0˜50.2 mm. The heat conductive tube 10 preferably has a thickness of 0.1˜0.2 mm.

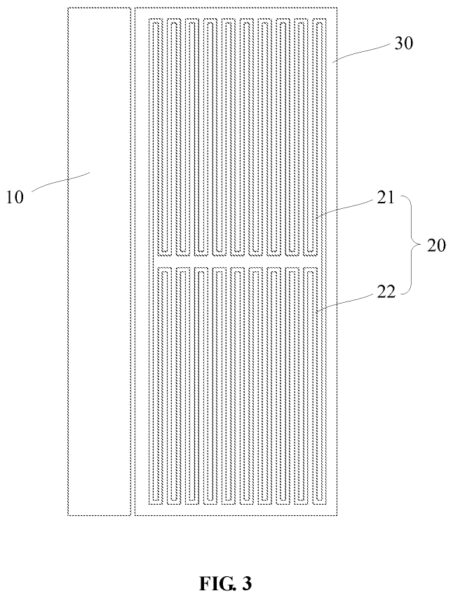

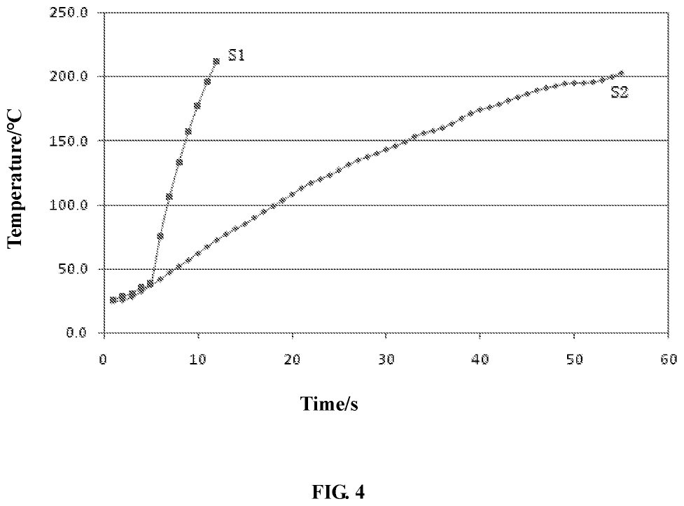

Furthermore, referring to FIG. 3, FIG. 3 is a schematic side view showing the resistance heating trace 20 and the ceramic substrate layer 30 extending along a circumferential direction of the heat conductive tube 10. The resistance heating trace 20 includes a first heating trace 21 and a second heating trace 22 both of which are in a spacing distribution along the longitudinal direction of the heat conductive tube 10. The first heating trace 21 and the second heating trace 22 are respectively used to heat different areas of a heating cavity 11 of the heat conductive tube 10 distributed along the longitudinal direction of the heat conductive tube 10. Meanwhile, sectional heating can be achieved in order to satisfy respective heating when cigarettes are in different smoking stages and to ensure uniformity and steadiness of a whole smoking amount. Alternatively, in another preferred embodiment in accordance with the present invention, the first heating trace 21 and the second heating trace 22 are respectively set to have different heating temperatures so as to satisfy requirement for more differential controls.

According to a need of independent control, the first heating trace 21 and the second heating trace 22 can differentially respectively have electrode pins of their own used for electrical circuit connection so that the first heating trace 21 and the second heating trace 22 can be independently controlled for heating. Further referring to FIG. 1, as adopted in a preferred embodiment shown in FIG. 1, the electrode pins mentioned above include a first pin 121, a second pin 122 and a third pin 123. One of the first, second and third pins 121, 122, 123 is used as a common pin, and the rest of the first, second and third pins 121, 122, 123 are disposed and used to be respectively electrically connected with the first heating trace 21 and the second heating trace 22, correspondingly. Taking a preferred embodiment as an example, the first pin 121 is used as a negative common pin to be electrically connected with a negative electrode of a power source. The second pin 122 is used as a positive pin of the first heating trace 21 to be electrically connected with a positive electrode of the power source. The third pin 123 is used as a positive pin of the second heating trace 22 to be electrically connected with the positive electrode of the power source. In practice, a welding point of the first pin 121 to be welded with the resistance heating trace 20 is exactly an adjoining portion of the first heating trace 21 and the second heating trace 22 so that the first pin 121 can be commonly used by both of the first heating trace 21 and the second heating trace 22.

Further in another preferred embodiment in accordance with the present invention, the resistance heating trace 20 includes one or plural heating circuits in a spacing distribution. Electric resistance material for the heating circuits can be selected from metal or alloy material having a specified temperature coefficient of resistance, such as a positive temperature coefficient or a negative temperature coefficient. As a result, the heating circuits can be not only used as an electric resistance heater, but also be used as a temperature sensor for sensing a real-time working temperature of heating components. In another preferred embodiment in accordance with the present invention, the resistance heating trace 20 includes at least a first heating circuit and a second heating circuit. The first heating circuit and the second heating circuit have different temperature coefficients of resistance. Among them, a temperature coefficient of resistance of the first heating circuit is set to satisfy a need for heating cigarette, and a temperature coefficient of resistance of the second heating circuit is set to satisfy a need for sensing temperatures of heating components.

Meanwhile, based on electrical conductivity requirement for avoiding short circuits, it is required to process an insulative treatment, such as surface oxidation, anodic oxidation, insulative layer plating or enameling, etc., on an outer surface of the resistance heating trace 20 relative to the heat conductive tube 10 when the heat conductive tube 10 is made from metal or alloy material in order to electrically insulate the resistance heating trace 20 from the heat conductive tube 10.

A manufacturing method of the above structure of the cigarette heating assembly in accordance with a preferred embodiment of the present invention is proceeded by adopting the following steps.

In a step of S10, a heating precursor layer 20a is formed on a surface of a ceramic rough blank layer 30a via silk screen printing to acquire a ceramic heating precursor.

In a step of S20, the ceramic heating precursor acquired from the step of S10 is wound and convoluted on an outer surface of a heat conductive tube 10a to form a heating assembly precursor.

In a step of S30, after the heating assembly precursor is baked and solidified under a temperature between 70˜100° C., the baked heating assembly precursor is sintered under a temperature between 800˜1,200° C. to acquire the cigarette heating assembly.

In the above method, after the heating precursor layer 20a is printed on the surface of the ceramic rough blank layer 30a, the ceramic rough blank layer printed with the heating precursor layer is wound and convoluted on the outer surface of the heat conductive tube 10a, and then the convoluted heat conductive tube is sintered to manufacture the cigarette heating assembly. The printing process of the heating precursor layer 20a is proceeded on the flat surface of the ceramic rough blank layer to ensure a uniform thickness of the formed heating precursor layer 20a and compact assembly of the heating precursor layer with the ceramic rough blank layer. Besides, the ceramic rough blank layer printed with the heating precursor layer is wound and convoluted on the heat conductive tube 10a for assembly before sintering, and the convoluted heat conductive tube is sintered for assembly under support of material of the heat conductive tube 10a. As a result, heat ablation deformation on the acquired cigarette heating assembly can be suppressed, and electric resistance stability and temperature raising efficiency of heat conductivity can be easily maintained.

Meanwhile, the ceramic rough blank layer 30a used in the step of S10 is acquired by uniformly blending raw material of ceramic powders with a certain sintering promoter and then being pressed together. The ceramic powders can be property changing or doping alumina ceramic powders based on quality requirement of even, straight compactness in practice and based on effect of substrate material used as an outermost heat insulation layer. The ceramic powders are preferably formulated as a composition of 45%˜50% of alumina, 35%˜40% of silicon dioxide, 5%˜10% of calcium oxide and 7%˜9% of magnesium oxide.

In addition, the sintering promoter includes solvents, binders, dispersants and plasticizers, and is blended and formulated based on weight percentages of 75% to 80% of solvents, 10% to 15% of binders, 2.5% to 3.5% of dispersants and 5 to 10% of plasticizers. In manufacturing preparation of a rough blank of the ceramic substrate of the present application, the solvents can be water. The binders are polyvinyl alcohol (PVA), methyl cellulose (MC) or polyacrylic acid (PAA), etc. The dispersants are sodium polyacrylate, sodium polyphosphate or sodium citrate, etc. The plasticizers are dibutyl phthalate (DBP), glycerol (glycerin), or polyethylene glycol (PEG), etc. When material of the rough blank is blended, the ceramic powders and the sintering promoter are blended based on a mass ratio of 1:1 to 2.5:1.

The material used for the heating drive body layer 20a can be pure nickel, nickel-chromium alloy, nickel-iron alloy, iron-chromium alloy, iron-chromium aluminum alloy, titanium alloy or stainless steel, etc. The drive body powder and sintering aid of these materials are uniformly prepared during preparation. Mix into a slurry, and then print on the surface of the ceramic green layer 30a according to the desired shape.

In step S20, the ceramic heating drive body printed in step S10 is wound and combined on the outer surface of the heat pipe 10a. The final step S30 is to bake and solidify the heating component driver body combined with the winding and low-temperature sintering. First, the ceramic green embryo and the printed circuit are cured by baking to ensure stable circuit resistance; after curing, the ceramic layer is co-fired at low temperature. The printed resistor heating track, and the heat pipe are sintered together to form a heating component.

On the basis of the above manner and structure, in order to further reflect the heating rate and resistance stability of the heat generating component obtained by the preparation, the following specific examples are used as an example for description.

S00: Prepare ceramic powder with weight percentages of aluminum oxide 48%, silicon dioxide 36%, calcium oxide 8%, and magnesium oxide 8%; and the weight ratio of the ceramic powder and the sintering aid is 2:1 to be mixed and pressed into thickness 0.15 mm ceramic germ layer 30a; among them, 80% water in the sintering aid, 12% polyvinyl alcohol as a binder, 2.5% sodium citrate as a dispersant, and 5.5% glycerin as a plasticizer.

S10, then mix pure nickel metal powder and purchased printing and sintering aids (about 90% is terpineol, about 5% is ethyl cellulose, and the rest are functional additives supplemented by the manufacturer) into a mixed slurry; The heating drive body layer 20a is formed by printing on the surface of the ceramic green layer 30a of step SOO by screen printing to obtain a ceramic heating drive body.

S20, the ceramic heating drive body of step S10 is wound and attached to the stainless steel tube after the surface oxidation treatment to form a heating component drive body; wherein the wall thickness of the stainless steel tube is 0.1 mm.

S30: Heat the heating component drive body at 100° C. for 5 minutes to solidify, and then sinter it in a vacuum furnace; during the sintering process, it is heated to 1000° C. at a rate of 10° C./min, and after holding for 1 hour, it is taken out as prepared in the example Cigarette heating components.

In the above embodiment, the resistance heating track 20 is prepared by using a nickel heating circuit with a resistance of 0.8 ohm. The heating test is compared with a conventional ceramic heating tube of the same resistance specification. The result is shown in FIG. 3; among them, S1 in FIG. 3 is the temperature rise curve on the inner wall of the cigarette heating assembly prepared in the embodiment, S2 is the temperature rise curve of the inner wall of the conventional ceramic heating tube. It can be seen from the figure that the heating time of the ceramic heating tube is also 54 s when the temperature is raised to 200 degrees, and the heating time of the cigarette heating assembly of the embodiment is 10 s.

The resistance value changes after 50 times of energization cycles were further tested, and the comparison results are as follows:

| | Sample | Resistance Value | | Resistance Value | |
|---|---|---|---|---|---|
| | No. | after Sintering | | after 50 Cycles | |
| Embodiment | 3 | 0.80 ± 0.01 | ohm (Ω) | 0.86~0.91 | ohm (Ω) |
| of the | | | | | |
| Present | | | | | |
| Invention | | | | | |
| Conventional | 1 | 0.82 | ohm (Ω) | 1.08 | ohm (Ω) |
| Ceramic | | | | | |
| Heating | | | | | |
| Tube | | | | | |

From the above test results, it can be seen that the common holding structure formed by flat printing on the ceramic green embryo and then winding it on the heat-conducting tube and sintering in this embodiment makes the resistance heating track much flat and stable, and has better resistance. Value stability and longevity.

The application further proposes an electrically heated smoking device. The electrically heated smoking device includes a cigarette heater and a power supply for supplying power to the cigarette heater; the cigarette heater uses the above-described cigarette heating assembly; The two ends of the resistance heating track in the heating component are respectively connected with the positive and negative poles of the power supply by pins to work.

It should be noted that the specification of the present invention and its accompanying drawings provides preferred embodiments of the present invention, but is not limited to the preferred embodiments described in this specification. Furthermore, for those of ordinary skill in the art, improvements or transformations can be made based on the above descriptions, and all these improvements and transformations should belong to the protection scope of the appended claims of the present invention.

1. A cigarette heating assembly, wherein the cigarette heating assembly comprises a longitudinal heat conductive tube, a substrate layer and a resistance heating trace formed on the substrate layer, the heat conductive tube comprises an inner surface and an outer surface oppositely facing each other along a radial direction of the heat conductive tube, the substrate layer is solidified on the outer surface of the heat conductive tube, the resistance heating trace is located between the substrate layer and the heat conductive tube, and extends along a longitudinal direction of the heat conductive tube, a thermal conductivity of material of the heat conductive tube is larger than a thermal conductivity of material of the substrate layer;
a heating cavity for accommodating cigarettes is formed on the inner surface.

2. The cigarette heating assembly as claimed in claim 1, wherein the substrate layer comprises a ceramic substrate layer, a thickness of the ceramic substrate layer is 0.0˜50.2 mm.

3. The cigarette heating assembly as claimed in claim 2, wherein the ceramic substrate layer is made from a flexible flat plate-like ceramic wafer being wound and convoluted, and then sintered and solidified on the outer surface of the heat conductive tube, the resistance heating trace is a metal heating circuit printed on at least one flat surface of the flat plate-like ceramic wafer.

4. The cigarette heating assembly as claimed in claim 1, wherein the heat conductive tube comprises a metal tube having a thickness of 0.1˜0.2 mm.

5. The cigarette heating assembly as claimed in claim 4, wherein an insulative layer is formed on an outer surface of the metal tube to electrically insulate the metal tube from the resistance heating trace.

6. The cigarette heating assembly as claimed in claim 1, wherein the resistance heating trace comprises one or a plurality of heating circuits in a spacing distribution, the plurality of heating circuits have specified temperature coefficients of resistance so that the plurality of heating circuits are not only used as an electric resistance heater, but also are used as a temperature sensor for sensing temperatures of the cigarette heating assembly.

7. The cigarette heating assembly as claimed in claim 1, wherein the resistance heating trace comprises at least a heating circuit and a temperature sensing circuit having different temperature coefficients of resistance;
a temperature coefficient of resistance of the heating circuit is set to satisfy use of an electric resistance heater, and a temperature coefficient of resistance of the temperature sensing circuit is set to satisfy use of a temperature sensor for sensing temperatures of the cigarette heating assembly.

8. The cigarette heating assembly as claimed in claim 1, wherein the resistance heating trace comprises at least a first heating trace and a second heating trace both of which are in a spacing distribution along the longitudinal direction of the heat conductive tube, the first heating trace and the second heating trace are used to heat different areas of the heating cavity distributed along the longitudinal direction of the heat conductive tube via heat conduction of the heat conductive tube along the radial direction of the heat conductive tube.

9. The cigarette heating assembly as claimed in claim 8, wherein the first heating trace and the second heating trace are differentially respectively electrically connected with electrode pins for circuit input so that both of the first heating trace and the second heating trace are independently controlled for heating.

10. An electric heating smoking device, comprising a cigarette heating device, and a power source used for powering the cigarette heating device, wherein the cigarette heating device is the cigarette heating assembly as claimed in claim 1.

11. An electric heating smoking device, comprising a cigarette heating device, and a power source used for powering the cigarette heating device, wherein the cigarette heating device is the cigarette heating assembly as claimed in claim 2.

12. An electric heating smoking device, comprising a cigarette heating device, and a power source used for powering the cigarette heating device, wherein the cigarette heating device is the cigarette heating assembly as claimed in claim 3.

13. An electric heating smoking device, comprising a cigarette heating device, and a power source used for powering the cigarette heating device, wherein the cigarette heating device is the cigarette heating assembly as claimed in claim 4.

14. An electric heating smoking device, comprising a cigarette heating device, and a power source used for powering the cigarette heating device, wherein the cigarette heating device is the cigarette heating assembly as claimed in claim 5.

15. An electric heating smoking device, comprising a cigarette heating device, and a power source used for powering the cigarette heating device, wherein the cigarette heating device is the cigarette heating assembly as claimed in claim 6.

16. An electric heating smoking device, comprising a cigarette heating device, and a power source used for powering the cigarette heating device, wherein the cigarette heating device is the cigarette heating assembly as claimed in claim 7.

17. An electric heating smoking device, comprising a cigarette heating device, and a power source used for powering the cigarette heating device, wherein the cigarette heating device is the cigarette heating assembly as claimed in claim 8.

18. An electric heating smoking device, comprising a cigarette heating device, and a power source used for powering the cigarette heating device, wherein the cigarette heating device is the cigarette heating assembly as claimed in claim 9.
